(19) United States
(12) Patent Application Publication
(10) Pub. No.: US 2021/0294361 A1
(43) Pub. Date: Sep. 23, 2021

(54) PROCESS FLUID MONITORING SYSTEM

(71) Applicant: Baker Hughes Oilfield Operations LLC, Houston, TX (US)

(72) Inventors: Jason Moses, Houston, TX (US); Tracey Spann Jackson, Houston, TX (US)

(21) Appl. No.: 16/827,704

(22) Filed: Mar. 23, 2020

(51) Int. Cl. G05D 21/02; G05D 7/06; B01D 36/02; B01D 35/147; B01D 37/00; B01D 15/08

(52) U.S. Cl. CPC G05D 21/02; G05D 7/0635; B01D 36/02; C02F 1/685; B01D 37/00; B01D 15/08; B01D 35/147

(57) ABSTRACT

A monitoring assembly includes a diverter, a fluid delivery network, an analysis subsystem, and a pump. The diverter be configured to fluidly couple to a single port of a process pipe. The network can be configured to receive a process fluid including an incumbent additive from the diverter. The analysis subsystem can be configured to receive the process fluid from the network, to measure a predetermined property of the received process fluid within a sensing chamber, and to output a signal representing the measured property. The pump can be configured to urge the process fluid from the analysis subsystem to the diverter via the network. The assembly can also include a conditioning subsystem configured to treat the process fluid with a process additive prior to measurement. The assembly can further include a filtration subsystem configured to filter the process fluid prior to measurement.

### BACKGROUND

Pipes can be used to transport fluids, such as water or fuels (e.g., natural gas, oil, etc.) over long distances. Under some circumstances, additives can be mixed with the fluid to modify one or more fluid properties. In one example, corrosion inhibiting additives can be employed to reduce corrosion of the pipeline material by the fluid. In another example, drag reducing agents can be employed to reduce turbulence in the pipe to facilitate transport of the fluid.

It can be desirable to measure the effect of additives on the transported fluid to confirm whether an additive is performing its intended function. With this information, additives that perform their intended function can be maintained, while additives that fail to perform their intended function can be modified or replaced. Furthermore, cost-benefit analyses can be performed to determine return on investment (ROI) for different additives.

A variety of techniques have been developed for monitoring properties of fluids transported by pipe. One class of techniques involves extraction of fluid samples or probes (e.g., test coupons) from the pipe and subsequent analysis to provide discrete fluid property measurements. Another class of techniques involves analysis of data output by sensors installed within a pipe to provide continuous fluid property measurements.

### SUMMARY

However, such existing techniques can be unsuitable for screening multiple additive chemistries in rapid succession and obtaining real-time fluid performance data. In one aspect, techniques that require sample extraction from a pipe can incur delay due to the extraction process. Thus, it can be difficult to characterize multiple additives in rapid succession.

In another aspect, fluids samples extracted from the pipe can contain one or more pre-existing additives, referred to as incumbents, and these incumbents can interfere with study of the extracted fluid sample. In one example, a surfactant can be present that lowers the corrosion rate of a fluid study taken to measure the corrosivity of the pipeline fluid when a corrosion inhibiter is added. Other interfering incumbents can include biocides, oxygen scavengers, and scale inhibitors.

In an additional aspect, under circumstances where the properties of the sample fluid or probe change between removal from the pipe and analysis (e.g., due to different environmental conditions, time, etc.), fluid property measurements can be unrepresentative of an additive's effect on the pipeline fluid within the pipeline.

In a further aspect, under some circumstances, pipe conditions can vary from expectation and cause additives to behave differently than expected. In worst case scenarios, such unexpected additive behavior can result in fluid contamination and/or pipe damage. Thus, use of techniques that measure fluid properties within the pipe to screen multiple additive chemistries in succession are subject to elevated risk.

In general, improved systems and methods are provided for screening the effect of different additive chemistries on a fluid within a pipe in rapid succession and obtaining real-time fluid performance data. Examples of fluid properties can include corrosion rate of the pipeline material by the fluid being transported, pH, and dissolved gas concentration.

As discussed in detail below, a monitoring assembly can be configured to couple to a pipe at a single existing port of the pipe. A fluid sample can be received from the pipe by the monitoring assembly and, after monitoring is completed, the monitoring assembly can return the fluid to the pipe at the single port. The single port can be an existing coupon-monitoring port formed within the pipe. As a result, embodiments of the monitoring assembly can replace existing coupon-based monitoring systems without altering the pipeline itself.

In an embodiment, a monitoring assembly is provided and includes a diverter, a fluid delivery network, an analysis subsystem, and a pump. The diverter can include a diverter pipe and a three-way junction. The diverter pipe can extend between a first end and a second end. The three-way junction can include first and second openings positioned opposite one another along an axis A and a third opening positioned transverse to the axis A. The three-way junction can be configured to fluidly couple to a single port of a process pipe including a port tube and a port valve positioned therein. The fluid delivery network can extend between a first end and a second end. The first end of the fluid delivery network can be configured to fluidly couple to the first end of the diverter pipe and the second end of the fluid delivery network can be configured to fluidly couple to the third opening of the three-way junction. When the three-way junction is fluidly coupled to the single port of the process pipe, the diverter pipe can be configured to move between a retracted position and an extended position. In the retracted position, the second end of the diverter pipe does not extend through the port valve. In the extended position, the second end of the diverter pipe can extend through the port valve and transport a process fluid including an incumbent additive from the process pipe to the first end of the fluid delivery network. The analysis subsystem can be configured to receive the process fluid from the fluid delivery network, to measure a predetermined property of the received process fluid within a sensing chamber, and to output a signal representing the measured predetermined property. The analysis subsystem can include one or more processors. The pump can be configured to urge the process fluid from the analysis subsystem to the diverter via the second end of the fluid delivery network. An outer wall of the diverter pipe and an inner wall of the port tube can form a channel extending from the three-way junction to the process pipe configured to receive the process fluid from the second end of the fluid delivery network.

In another embodiment, the diverter pipe and the port tube can be approximately concentric with respect to one another about the axis A when the three-way junction is coupled to the port tube.

In another embodiment, the second end of the diverter pipe can be configured to extend a predetermined distance beyond a wall of the process pipe in the extended position.

In another embodiment, the system further includes a controller in signal communication with one or more valves of the fluid delivery network. The controller can be configured to provide commands to the valves for directing the process fluid received within the fluid delivery network.

In another embodiment, the system can further include a filtration subsystem in fluid communication with the fluid delivery network downstream from the diverter pipe. The filtration subsystem can include a first filter configured to remove at least a portion of the incumbent additive from the process fluid to produce a filtered process fluid, and to output the filtered process fluid to the fluid delivery network.

In another embodiment, the incumbent additive is a corrosion inhibitor and the first filter can include a chemical filter configured to remove at least a portion of the corrosion inhibitor from the process fluid.

In another embodiment, the filtration subsystem can further include a second filter configured to remove selected particulates from the process fluid.

In another embodiment, the fluid delivery network can further include a bypass portion configured to divert the process fluid from at least a portion of the filtration subsystem.

In another embodiment, the bypass portion can further include a bypass channel and one or more bypass valves. The bypass channel can include a first end positioned upstream from the first filter and a second end positioned downstream from the incumbent filter. The one or more bypass valves can be in signal communication with the controller. The controller can be configured to command the one or more bypass valves to move between a first configuration that permits flow of the process fluid to the first filter and a second configuration that diverts flow of the process fluid away from the first filter and into the bypass channel.

In another embodiment, the system can further include a conditioning subsystem. The conditioning subsystem can include a reservoir and a reservoir valve. The reservoir can contain a process additive. The reservoir valve can be in fluid communication with the reservoir and the fluid delivery network upstream from the analysis subsystem.

In another embodiment, the controller can be configured to command the reservoir valve. The controller can command the reservoir valve to permit flow of a predetermined amount of the process additive to the fluid delivery network to provide a treated process fluid including the process fluid and the process additive to the analysis subsystem. The controller can also command the reservoir valve to inhibit flow of the process additive to the fluid delivery network to provide the process fluid without the process additive to the analysis subsystem.

In another embodiment, the predetermined property is a corrosion rate of a material forming the process pipe.

In an embodiment a method is provided. The method can include coupling a diverter to a single port of a process pipe including a port tube and a port valve. The diverter can include a diverter pipe and a three-way junction. The diverter pipe can extend between a first end and a second end. The three-way junction can include first and second openings positioned opposite one another along an axis A and a third opening positioned transverse to the axis A. The first opening of the three-way junction can be fluidly coupled to the port tube. The method can also include coupling a first end of a fluid delivery network to the first end of the diverter pipe and a second end of the fluid delivery network to the third opening of the three-way junction. The method can further include receiving, by the fluid delivery network, a process fluid sample from the process pipe via the diverter. The process fluid sample can include an incumbent additive. The method can additionally include receiving, by an analysis subsystem, the process fluid sample. The method can further include measuring a predetermined property of the process fluid sample by the analysis subsystem. The method can also include outputting, by the analysis subsystem, a sensor signal representative of the measured predetermined property of the process fluid sample. The method can additionally include directing the process fluid sample from the analysis subsystem to the third opening of the three-way junction via the fluid delivery network after sensing the predetermined property. The method can further include directing the process fluid sample from the three-way junction to the process pipe via a channel formed by an outer wall of the diverter pipe and an inner wall of the port tube.

In another embodiment, the diverter pipe and the port tube can be approximately concentric with respect to one another about the axis A when the three-way junction is coupled to the port tube.

In another embodiment, the diverter pipe can be configured to move between a retracted position and an extended position. In the retracted position, the second end of the diverter pipe does not extend through the port valve. In the extended position, the second end of the diverter pipe can extend through the port valve.

In another embodiment, the diverter pipe can be configured to extend a predetermined distance beyond a wall of the process pipe in the extended position.

In another embodiment, the predetermined property can be a corrosion rate of a material forming the process pipe.

In another embodiment, the method can further include directing the process fluid sample from the diverter pipe to a filtration subsystem positioned upstream from the analysis subsystem. The method can also include removing at least a portion of the incumbent additive from the process fluid sample by the filtration subsystem to provide a filtered process fluid. The method can additionally include directing the filtered process fluid to the analysis subsystem.

In another embodiment, the incumbent additive can be a corrosion inhibitor.

In another embodiment, the filtration subsystem can be further configured to remove selected particulates from the process fluid.

In another embodiment, the method can further include directing the process fluid sample from the filtration subsystem to a conditioning subsystem upstream from the analysis subsystem and downstream from the filtration subsystem. The method can also include releasing a dosage of a process additive from the conditioning subsystem to the fluid delivery network downstream from the filtration subsystem to produce a treated process fluid sample including the filtered process fluid and the process additive. The method can additionally include directing the treated process fluid sample to the analysis subsystem for measurement of the predetermined property.

In another embodiment, the method can further include directing the process fluid sample from the diverter pipe to a conditioning subsystem positioned upstream from the analysis subsystem. The method can also include releasing a dosage of a process additive from the conditioning subsystem to the fluid delivery network upstream from the analysis subsystem to produce a treated process fluid sample including the process fluid as-received by the diverter pipe and the process additive. The method can additionally include directing the treated process fluid sample to the analysis subsystem for measurement of the predetermined property.

### DESCRIPTION OF DRAWINGS

These and other features will be more readily understood from the following detailed description taken in conjunction with the accompanying drawings, in which:

FIG. 1 is a schematic diagram illustrating of one exemplary embodiment of an operating environment including a monitoring assembly coupled to a single port of a process pipe;

FIG. 2A is a schematic diagram illustrating the port of the process pipe of FIG. 1 in greater detail.

FIG. 2B is a schematic diagram illustrating the port of FIG. 2A coupled to a diverter of the monitoring assembly of FIG. 1;

FIG. 3A is a schematic diagram illustrating the monitoring assembly of FIG. 1 in greater detail;

FIG. 3B is a schematic diagram illustrating another embodiment of the monitoring assembly of FIG. 1 including a bypass reservoir; and

FIGS. 4A-4B are flow diagrams illustrating one exemplary embodiment of a method for diverting a process fluid from a process pipe and measuring the effects of one or more additives on fluid properties of the diverted process fluid.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Pipes can be used to transport fluids, such as water or fuels (e.g., natural gas, oil, etc.) over long distances. Under some circumstances, additives can be mixed with the fluid to modify one or more fluid properties. As an example, corrosion inhibitors can be added to prevent corrosion of the pipe by the fluid. Techniques have been developed for measuring the effect of additives on fluids transported by pipe. In one aspect, the effect of corrosion inhibitors can be monitored by measuring one or more properties of metal samples representative of the pipe material, referred to as coupons, before and after exposure to the fluid. In another aspect, some sensors can directly measure corrosion rate of the fluid within the pipe. However, under circumstances where the fluid contains multiple additives, two or more of the additives can affect a target fluid property and the effect of a single additive on the target fluid property can be difficult to determine. Therefore, improved systems and methods for testing the effect of additives, such as corrosion inhibitors, on fluid properties within a pipe are provided.

As discussed below, a monitoring assembly is provided that can mount to an existing coupon port in a pipe. The monitoring assembly can divert fluid from the pipe, remove existing additives from the fluid, and measure one or more target fluid properties to establish a baseline. Subsequently one or more selected additives can be added to the fluid and the target fluid properties can be measured again. In this manner, the baseline measurements of the target fluid properties can be directly compared to the target fluid properties when the one or more selected additives are present. Furthermore, the monitoring assembly can use the existing coupon port of the pipe to divert fluid from the pipe, without the need for modifications (e.g., hot work) to the pipe itself. The monitoring assembly can also rapidly test the effects of different additives in succession, allowing pipe operators to quickly determine suitable additives for fluid management.

Embodiments of systems and corresponding methods for monitoring the effects of additives on one or more properties of a fluid within a pipe are discussed herein. It can be understood that the disclosed embodiments are suitable for use with any fluid or pipe without limit.

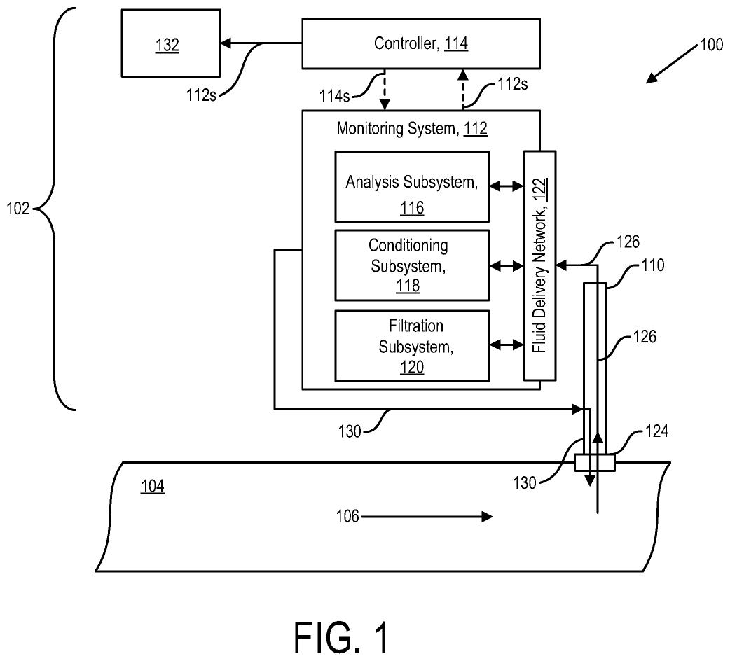

FIG. 1 illustrates one exemplary embodiment of an operating environment 100 including a monitoring assembly 102 in fluid communication with a process pipe 104. The monitoring assembly 102 can be configured to measure the effect of a process additive on a process fluid 106 contained within the process pipe 104. The illustrated monitoring assembly 102 includes a diverter 110, a monitoring system 112, and a controller 114. The diverter 110 can be configured to fluidly couple to the process pipe 104 via a single port 124. As discussed in greater detail, when the diverter 110 is inserted in the port 124, the process fluid 106 drawn into the monitoring assembly 102 from the process pipe 104 (e.g., influent 126) is kept separate from process fluid 106 returned to the process pipe 104 from the monitoring assembly 102 (e.g., effluent 130). That is, the influent 126 and effluent 130 can be inhibited from mixing with one another.

The monitoring system 112 can include an analysis subsystem 116, a conditioning subsystem 118, a filtration subsystem 120, and a fluid delivery network 122. The fluid delivery network 122 can be configured for fluid communication between diverter 110, the analysis subsystem 116, the conditioning subsystem 118, and the filtration subsystem 120. The analysis subsystem 116 can be configured to measure one or more predetermined properties of the process fluid 106. The conditioning subsystem 118 can be configured to deliver a predetermined amount of a process additive to the fluid delivery network 122 for combination with the process fluid 106. The filtration subsystem 120 can be configured to remove at least one selected component from the process fluid 106, such as particulates and/or incumbent additives already present in the process fluid 106.

Embodiments of the monitoring assembly 102 can be provided as fixed installation at the location of the process pipe 104 or in a portable form factor. One example of a portable form factor can include a ruggedized enclosure that provides environmental and impact protection to the monitoring assembly during travel. In another example, the monitoring assembly can be mounted to a movable skid.

In use, a sample of the process fluid 106 can be diverted from the process pipe 104 by the diverter 110 and received by the monitoring system 112 via the fluid delivery network 122 as influent 126. As an example, the controller 114 can be in communication with the fluid delivery network 122 and the monitoring system 112 and configured to provide signals 114s operative to direct flow of the process fluid 106 within the monitoring system 112 using one or more valves (not shown) positioned within the fluid delivery network 122.

In a first mode of operation, the analysis subsystem 116 can be configured to measure properties of the influent 126 in an as-received state. As an example, the controller 114 can command the fluid delivery network 122 to direct the influent 126 from the diverter 110 to the analysis subsystem 116 without filtration by the filtration subsystem 120 or addition of process additives by the conditioning subsystem 118. The analysis subsystem 116 can measure the predetermined property of the influent 126 in the as-received state to provide a baseline characterizing the effect of pre-existing or incumbent additives on the process fluid 106 within the process pipe 104. After this baseline measurement is made, the process fluid 106 can be directed from the analysis subsystem 116 to the diverter 110, via the fluid delivery network 122, for return to the process pipe 104 as effluent 130.

In a second mode of operation, the analysis subsystem 116 can be configured to measure properties of the influent 126 in a filtered state (e.g., filtered influent 126f). As an example, the fluid delivery network 122 can direct the influent 126 to the filtration subsystem 120, upstream from the analysis subsystem 116 and the conditioning subsystem 118. The filtration subsystem 120 can remove one or more selected component(s) from the influent 126, resulting in a filtered influent 126f. Measurements of the predetermined property of the filtered influent 126f by the analysis subsystem 116 can provide a baseline characterizing the process fluid 106 within the process pipe 104 without the selected incumbent additive(s). After this filtered baseline measurement is made, the filtered influent 126f can be directed from the analysis subsystem 116 to the diverter 110, via the fluid delivery network 122, for return to the process pipe 104 as effluent 130.

In a third mode of operation, the analysis subsystem 116 can be configured to measure properties of the influent 126 in a treated state (e.g., treated influent 126t). As an example, the conditioning subsystem 118, upstream from the analysis subsystem 116, can deliver one or more process additives to the fluid delivery network 122 for mixing with the influent 126 prior to analysis by the analysis subsystem 116. The combination of the influent 126 (filtered or as-received) with the process additive(s) provides the treated influent 126t. Measurements of the predetermined property of the treated influent 126t by the analysis subsystem 116 can estimate the effect of newly added process additive(s) on the process fluid 106 within the process pipe 104. After the treated influent 126t is characterized, it can be directed from the analysis subsystem 116 to the diverter 110, via the fluid delivery network 122, for return to the process pipe 104 as effluent 130. Optionally, the treated influent 126t can be subjected to further filtration prior to receipt by the diverter 110. Under some circumstances, filtering the treated influent 126t can be desirable to avoid contaminating the process fluid 106 within the process pipe 104 with the process additives of the treated influent 126t.

Following measurement of one or more properties of the influent 126 by the analysis subsystem 116, the monitoring system 112 (e.g., the analysis subsystem 116) can output one or more measurement signals 112s to the controller 114 representing the predetermined property measurement(s). The controller 114 can also be configured to output the received measurement signals 112s to one or more computing devices 132 for storage, display, and/or further analysis. Alternatively or additionally, the controller 114 can be configured to store, display, and/or perform further analysis on the received measurement signals 112s.

As an example, the controller 114 and/or computing devices 132 can perform comparisons of the predetermined property measurement(s) acquired for the influent 126 in any combination of the as-received state, the filtered state, and the treated state. In one aspect, comparing property measurements acquired for the influent 126 in the as-received and filtered states can quantify the effect of incumbent additives. In another aspect, comparing property measurements acquired for the influent 126 in the filtered and treated states can quantify the effect of newly added process additives alone, without incumbent additives. In a further aspect, comparing property measurements acquired for the influent 126 in the as-received and treated states can quantify the effect of newly added process additives in combination with incumbent additives. In this manner, the effect of incumbent additives and new process additives can be directly compared to one another. Furthermore, multiple new additive chemistries can be screened in rapid succession to obtain real-time performance data of the new process additives with respect to one another.

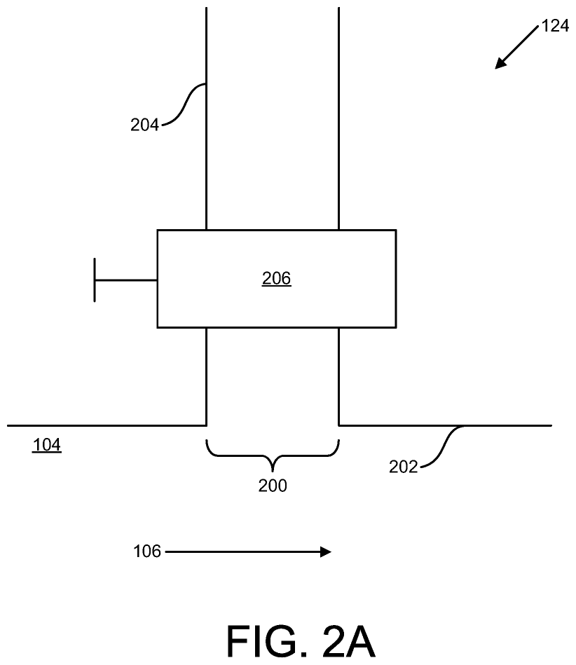

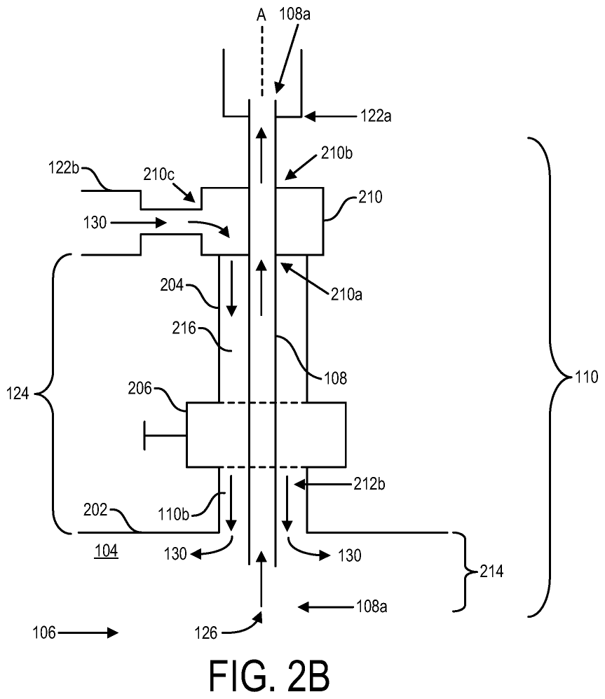

FIGS. 2A-2B illustrate the diverter 110 and the port 124 in greater detail. The port 124 is shown alone in FIG. 2A and engaged with the diverter 110 in FIG. 2B. As shown in FIG. 2A, the port 124 includes an aperture 200 formed through an outer wall 202 of the process pipe 104 and a port tube 204 in fluid communication with the aperture 200. A port valve 206 can also be positioned along the length of the port tube 204. In certain embodiments, the port valve 206 can be normally open valve (e.g., a ball valve). That is, the port valve 206 can be biased in an open position, allowing fluid flow therethrough during normal operation, and requiring actuation to adopt a closed position that inhibits fluid flow therethrough.

As shown in FIG. 2B, the port 124 can be a coupon port and the diverter 110 can include a diverter pipe 108 and a coupling mechanism 210. As an example, the coupling mechanism 210 can be a T-junction or three-way junction having first and second openings 210a, 210b opposed along an axis A and a third opening 210c extending transverse to the axis A. The diverter pipe 108 can extend through the T-junction through the first and second openings 210a, 210b. The diverter pipe 108 can be held in place with respect to the coupling mechanism 210 by fittings, not shown. The diameter of the diverter pipe 108 is less than the diameter of the port tube 204 and the port valve 206, allowing the diverter pipe 108 to extend through the port tube 204 and port valve 206.

In use, the diverter 110 is coupled to the port tube 204 and the fluid delivery network 122. A first end 108a of the diverter pipe 108 is fluidly coupled to a first end 122a of the fluid delivery network 122. The coupling mechanism 210 is coupled to the port tube 204 (e.g., via mating threads on or adjacent to the first opening 210a and on the port tube 204) and forms a fluid tight seal. In certain embodiments, the diverter pipe 108 and the port tube 204 are approximately concentric about the axis A when the three-way junction 210 is coupled to the port tube 204. The third opening 210c is coupled to a second end 122b of the fluid delivery network 122 and forms a fluid tight seal therewith.

In an embodiment, the diverter pipe 108 can be retractable (e.g., manual retraction and extension by hand). Beneficially, this configuration can allow for installation and adjustment in situ. As an example, the port valve 206 can initially be closed until the coupling mechanism 210 is secured to the port tube 204 and the fluid delivery network 122. While the coupling mechanism 210 is detached from the port valve 206 and the fluid delivery network 122, the diverter pipe 108 can be in a retracted position, where a second end 108b of the diverter pipe 108 is positioned between the coupling mechanism 210 and the port valve 206. The port valve 206 can be opened and the diverter pipe 108 moved to an extended position, where the second end 108b of the diverter pipe 108 advanced through the port valve 206 the towards the process pipe 104. As shown in FIG. 2B, the second end 108b of the diverter pipe 108 is positioned within the process pipe 104. However, in alternative embodiments, the extended position of the diverter pipe can place the second end at a position between the outer surface of the process pipe and the port valve.

As further shown in FIG. 2B, the diverter 110 can be configured to act as a side stream type diverter to divert the process fluid 106 from the process pipe 104 to the monitoring system 112 and return fluid from the monitoring system 112 to the process pipe 104. Process fluid 106 can be drawn from the process pipe 104 into the second end 108b of the diverter pipe 108, through the aperture 200, as influent 126. The influent 126 can be urged through the diverter pipe 108 and for receipt by the fluid delivery network 122. The influent 126 can be directed, by the fluid delivery network, through the monitoring system 112 for monitoring one or more selected fluid properties.

After analysis is completed, the influent 126 can be returned to the process pipe 104 from the monitoring system 112 as effluent 130. Effluent 130 can exit the monitoring system 112 via the fluid delivery network 122 and received by the diverter 110. Space between an outer wall of the diverter pipe 108, an inner wall of the coupling mechanism 210, and an inner wall of the port tube 204 provides a channel for return of the effluent 130 to the process pipe 104.

The diverter 110 can be further configured to maintain isolation of the influent 126 from the effluent 130. In one aspect, the influent 126 is kept separate from the effluent 130 within the diverter 110 by the diverter pipe 108. In another aspect, as discussed above, the second end 108b of the diverter pipe 108 can extend within the process pipe 104 by a clearance distance 214 from the outer wall 202. As a result, the point at which influent 126 enters the diverter 110 (e.g., the second end 108b of the diverter pipe 108) is distanced from the point at which effluent 130 exits the diverter 110. Beneficially, this configuration avoids contamination of the influent 126 by the effluent 130.

However, in alternative embodiments, it can be desirable for the effluent to flow directly from the second end 122b of the fluid delivery network 122 to the first end 122a of the fluid delivery network 122 for return to the monitoring system, without return to the process pipe 104. When analyzing target properties of the fluid, it can be beneficial to analyze the same fluid. As an example, parametric studies of additive concentration can benefit from such a configuration. A baseline measurements of influent can be measured and the resulting effluent can be directly returned to the monitoring system. Subsequently, the additive concentration can be increased and the target fluid property measured again. By iterating on addition of additive, measurement, and return to the monitoring system, a single baseline measurement of a target property can be compared to measurements of the target property at multiple additive concentrations. Accordingly, an alternative embodiment of the diverter (not shown) the pipe can be configured to receive the effluent, bypassing the process pipe.

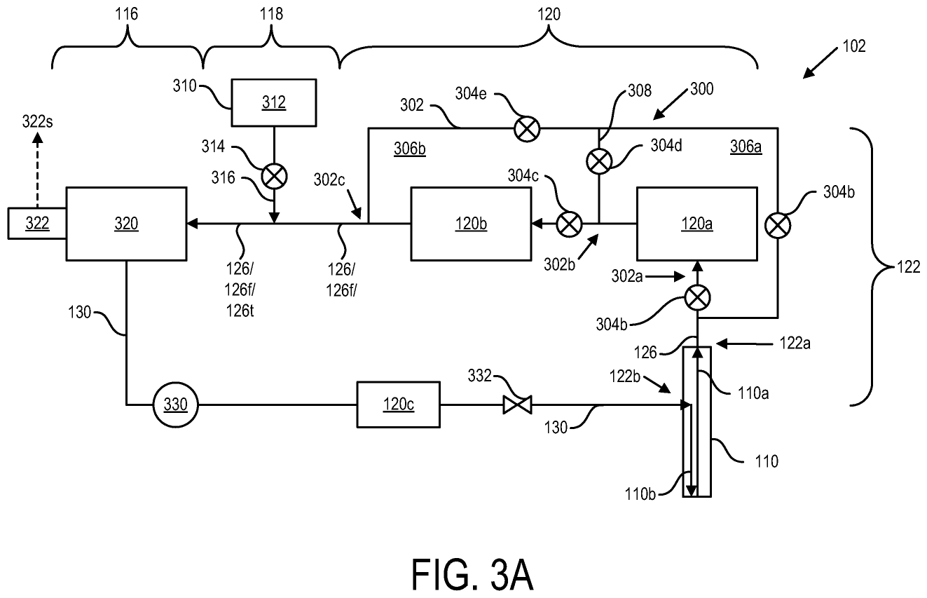

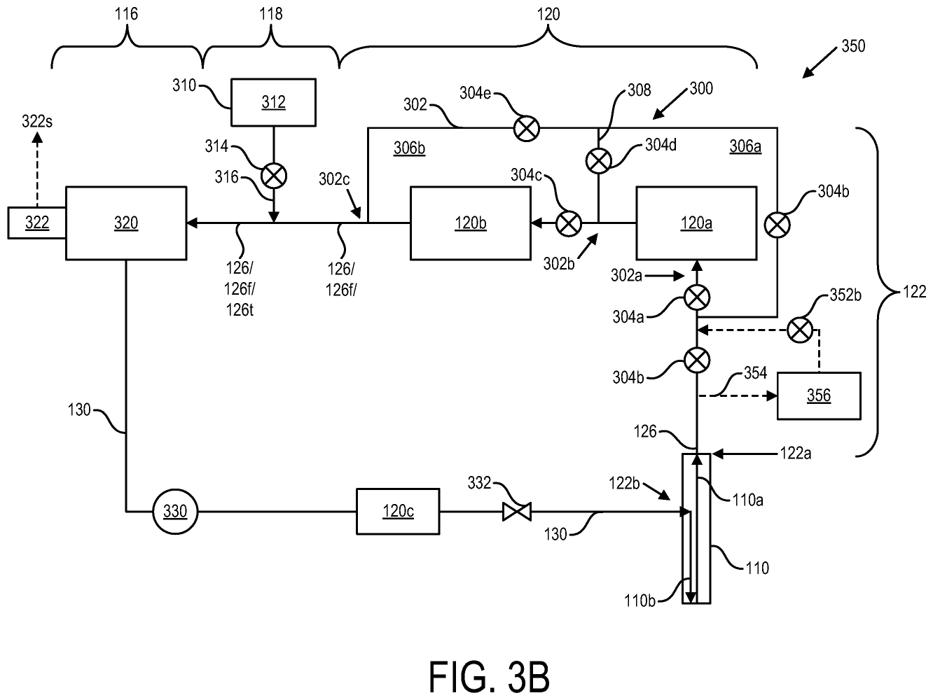

FIG. 3A illustrates the monitoring system of FIG. 1 in greater detail. As discussed above, the fluid delivery network 122 can form a closed loop starting from and ending at the diverter 110. The first end 122a of the fluid delivery network 122 can be coupled to the diverter pipe 108 (e.g., the first end 108a) and a second end 122b of the fluid delivery network 122 can be coupled to the coupling mechanism 210 (e.g., the third opening 210c of the three-way junction 210). The fluid delivery network 122 can also be in fluid communication with the analysis subsystem 116, the conditioning subsystem 118, and the filtration subsystem 120.

The fluid delivery network 122 can further include one or more valves in signal communication with the controller 114. As discussed below, the controller 114 can be configured to command the valves to open and close for direction of the influent 126 between selected ones of the analysis subsystem 116, the conditioning subsystem 118, and the filtration subsystem 120, and for delivery of one or more process additives (e.g., 312) to the fluid delivery network 122. In this manner, the monitoring assembly 102 can operate according to the first, second, or third operating modes to measure one or more properties of the process fluid 106 in as-received, filtered, and treated states, respectively. In alternative embodiments, one or more valves of the fluid delivery network can be manually actuated.

The filtration subsystem 120 can be positioned downstream from the diverter 110 and can include a first filter 120a, a second filter 120b, and a third filter 120c. As shown, the first filter 120a can be positioned between the diverter 110 and the second filter 120b. The second filter 120b can be positioned downstream from the first filter 120a, between the first filter 120a and the conditioning subsystem 118. The third filter 120c can be positioned downstream from the analysis subsystem 116, between the analysis subsystem 116 and the diverter 110. As discussed in detail below, the first and second filters 120a can be configured to remove one or more components (e.g., particulates, incumbent additives, etc.) from the influent 126 prior to the conditioning subsystem 118, while the third filter 120c can be configured to remove one or more new process additives added by the conditioning subsystem 118. The first filter 120a and the second filter 120b are illustrated in FIG. 3A as separate components. However, in alternative embodiments of the monitoring system, the first filter and the second filter can be combined into a single component upstream from the conditioning subsystem.

In certain embodiments, the influent 126 can include particulates. Due to their size (e.g., diameter or largest dimension) and/or composition, particulates can impair operation of and/or cause damage to the monitoring system 112 (e.g., the analysis subsystem 116, portions of the filtration subsystem 120, valves of the fluid delivery network 122, etc.). It can be beneficial to remove at least a portion of these particulates to prior to flow of the influent 126 to the remainder of the monitoring system 112. Accordingly, the first filter 120a can be configured to remove particulates from the influent 126. As an example, the first filter 120a can be configured to remove particulates possessing a selected size. In one embodiment, the selected size can be greater than a threshold amount. In another embodiment, the selected size can be less than about 100 μm.

The first filter 120a can adopt a variety of configurations. Under circumstances where the particulates are relatively easy to separate from the influent 126, the first filter 120a can include mechanical media (e.g., porous filter media) that is configured to inhibit passage of particulates that possess the selected size. Under circumstances where the particulates are relatively difficult to separate from the influent 126, a pretreatment can be employed in combination with filtration by the mechanical media. In one example, pretreatment can include use of filtration aids to induce flocculation (clumping together of fine particulates) to form larger particulates.

As discussed above, the influent 126 can include one or more incumbent additives. It can be desirable to measure fluid properties of the influent 126 without these incumbent additives (the filtered state) to provide a baseline for comparison with other states of the influent 126. Accordingly, the second filter 120b can include one or more components configured to remove selected incumbent additives from the influent 126 to yield filtered influent 126f. Examples of incumbent additives can include one or more of corrosion inhibitors, demulsifiers, scale inhibitors, biocides, viscosity reducers, oxygen scavengers, H₂S scavengers, paraffin inhibitors, kinetic hydrate inhibitors, water clarifiers, asphaltenes inhibitors, etc. Examples of the second filter 120b can include chemical filters that include media configured to separates the selected incumbent additive(s) from the influent 126 by adsorption or absorption.

The fluid delivery network 122 can also include a bypass portion 300 configured to divert the influent 126 from selected portions of the filtration subsystem 120. This allows selective filtration of the influent by one or both of the first filter 120a and the second filter 120b to provide the influent 126 in the filtered state, or bypass of the filtration subsystem 120 altogether to provide the influent 126 in the as-received state. The bypass portion 300 can include a bypass channel 302 and one or more bypass valves (e.g., 304a, 304b, 304c, 304d) in signal communication with the controller 114. The bypass channel 302 can include a first loop 306a configured to bypass the first filter 120a and a second loop 306b configured to bypass the second filter 120b. The first and second loops 306a, 306b can share a common segment 308

As shown in FIG. 3A, the first loop 306a extends from a first end 302a to a second end 302b. The first end 302a is positioned upstream from the first filter 120a, between the diverter 110 and the first filter 120a. The second end 302b is positioned downstream from the first filter 120a, between the first filter 120a and the second filter 120b. The first and second bypass valves 304a, 304b can be configured to selectively allow or inhibit passage of the influent 126 to the first filter 120a in response to commands from the controller 114. As an example, the first bypass valve 304a can be interposed between the diverter 110 and the first filter 120a. The second bypass valve 304b can be positioned along the first loop 306a, interposed between the first and second ends 302a, 302b of the bypass channel 302. The third bypass valve 304c can be interposed between the second end 302b of the bypass channel 302 and the second filter 120b.

The influent 126 received from the diverter pipe 108 can be directed to the first filter 120a or diverted around the first filter 120a. The influent 126 can be directed to the first filter 120a by commanding the first bypass valve 304a to open and the second bypass valve 304b to close. The influent 126 can be diverted around the first filter 120a by commanding the first bypass valve 304a to close and the second bypass valve 304b to open.

The second loop 306b can extends between the second end 302b and a third end 302c of the bypass channel 302. The third end 302c can be positioned downstream from the second filter 120b, between the second filter 120b and the conditioning subsystem 118. The third, fourth, and fifth bypass valves 304c, 304d, 304e can be configured to selectively allow or inhibit passage of the influent 126 to the second filter 120b in response to commands from the controller 114. As noted above, the third bypass valve 304c can be interposed between the second end 302b of the bypass channel 302 and the second filter 120b. The fourth bypass valve 304d can be positioned along the common segment 308 of the bypass channel 302. The fifth bypass valve 304e can be positioned along the second loop 306b, interposed between the common segment 308 and the second end 302b of the bypass channel 302.

Under circumstances where the influent 126 is received from the first filter 120a, the influent 126 can be directed to the second filter 120b or diverted around the second filter 120b to the third end 302c of the bypass channel 302. The influent 126 can be directed to the second filter 120b from the first filter 120a by commanding the third bypass valve 304c to open, and the fourth bypass valve 304d to close. The influent 126 can be diverted around the second filter 120b from the first filter 120a by commanding the second and the third bypass valves 304b, 304c to close, and the fourth and fifth bypass valves 304d, 304e to open.

Under circumstances where the influent 126 is diverted from the first filter 120a, the influent 126 can be directed to the second filter 120b or diverted around the second filter 120b to the third end 302c of the bypass channel 302. The influent 126 can be directed to the second filter 120b by commanding the third bypass valve 304c to open, and the fourth bypass valve 304d is commanded to close. The influent 126 can be diverted around the second filter 120b after diversion from the first filter 120a by commanding the fourth bypass valve 304d to close and the fifth bypass valve 304e to open.

In alternative embodiments, the configuration of the bypass portion can be changed from that illustrated in FIG. 3A. In one example, the bypass portion can be configured to allow diversion of the influent from only the first filter or only the second filter. In another example, the bypass portion can be omitted.

In alternative embodiments, the configuration of the filtration subsystem can be changed from that illustrated in FIG. 3A. In one embodiment, the first filter, the second filter, or the entire filtration subsystem can be omitted. As an example, under circumstances where particulates are not of concern, the first filter can be omitted. In a further example, under circumstances where removal of incumbent additives from the influent is not necessary, the second filter can be omitted. In an additional example, under circumstances where treated influent can be safely returned to the pipe without removal of new process additives, the third filter can be omitted.

In another embodiment, the first filter, the second filter, or both the first and second filters can include multiple components arranged in series or parallel configurations. Parallel configurations can be employed to improve throughput and/or to provide greater flexibility in filtration. For example, parallel filter components can possess different filter media (e.g., physical filter media configured for filtering different particle sizes, chemical filter media configured for filtering different process additives, etc.), allowing greater selectivity in filtration.

The conditioning subsystem 118 can be positioned downstream from the filtration subsystem 120 and can include a reservoir 310 in fluid communication with the fluid delivery network via a reservoir valve 314. The reservoir 310 can be configured to store one or more process additives 312. The reservoir valve 314 can be in signal communication with the controller 114 and operative to open and close in response to commands from the controller 114. Under circumstances where the reservoir valve 314 is commanded to close, the influent 126 (e.g., in the as-received state or the filtered state) can be received by the analysis subsystem 116 without treatment by the conditioning subsystem 118 for measurement of one or more fluid properties. Alternatively, under circumstances where the reservoir valve 314 is commanded to open, a selected dosage 316 (e.g., composition, volume, concentration, etc.) of the process additive 312 can be delivered to the fluid delivery network 122 for mixture with the influent 126 in the as-received state in the filtered state to form a treated influent 126t. The treated influent 126t can be subsequently received by the analysis subsystem 116 for measurement of one or more fluid properties.

Embodiments of the process additive 312 can adopt a variety of configurations. Examples of the process additive 312 can include corrosion inhibitors, drag reducers, demulsifiers, scale inhibitors, biocides, viscosity reducers, oxygen scavengers, H₂S scavengers, paraffin inhibitors, kinetic hydrate inhibitors, water clarifiers, asphaltenes inhibitors, etc.

The analysis subsystem 116 can be positioned downstream from the conditioning subsystem 118 can include a sensing chamber 320 and one or more sensors 322. The sensing chamber 320 can be in fluid communication with the fluid delivery network 122 and configured to receive the influent 126 in the as received state, as filtered influent 126f, or treated influent 126t. The sensors 322 can be configured to measure respective fluid properties of the influent 126/126f/126t and output one or more sensor signals 322s for receipt by the controller 114. Examples of fluid properties can include corrosion rate of the process pipe 104, concentration of gases (e.g., oxygen, carbon dioxide, carbon monoxide, nitrogen, H₂S), pH, water cut, physical properties of the influent 126 (e.g., temperature, pressure, flow rate, viscosity, drag, turbulence, salinity, density, conductivity). Examples of corrosion sensors can include electrical resistance probes, linear polarization resistance probes, electrochemical noise, weight loss coupon. Examples of gas concentration sensors can include, electrochemical, photoionization, semiconductor, infrared. Examples of pH sensors can include combination electrode, double electrode, calomel, ISFET, ISE. Examples of water cut sensors can include electronic water cut meters, RF transmittance, photo transmittance. Examples of physical property sensors can include thermometers, pressure sensors, flow meters, densitometer, rheometers, viscometers, UV-Vis, flash point instruments.

After completion of fluid property measurements by the analysis subsystem 116, the influent 126, filtered influent 126f, or treated influent 126t, now referred to collectively as effluent 130, can be returned to the process pipe 104 via the diverter 110 and port 124. In certain embodiments, a pump 330 (e.g., a diaphragm pump) can be positioned downstream from the analysis subsystem 116, between the analysis subsystem 116 and the diverter 110, to facilitate fluid return. A flow control valve 332 can be further provided in signal communication with the controller 114, downstream from the pump 330 (e.g., between the pump and the diverter 110). In response to commands from the controller 114, the flow control valve 332 can open or close by a suitable amount to achieve a desired flow rate.

As indicated above, the third filter 120c can also be positioned downstream from the analysis subsystem 116, between the analysis subsystem 116 and the diverter 110. The third filter 120c can be configured to remove at least a portion of the process additive 312 from the influent 126, when present, to yield filtered influent 126f. Removing the process additive 312 can be desirable under circumstances where it is undesirable to add the process additive 312 to the process pipe 104. As an example, when field trialing a new process additive. In another example, when the process additive being studied, or a high concentration of additive, would create problematic emulsions or foaming if returned to the process pipe 104.

FIG. 3B illustrates an alternative embodiment of the monitoring assembly 102 in the form of monitoring assembly 350. The monitoring assembly 350 modifies the monitoring assembly 102 to include a reservoir subassembly. The reservoir subassembly includes a first bypass valve 352a, a second bypass valve 352b, a bypass line 354, and a reservoir 356. The first bypass valve 352a is positioned downstream from the diverter 110 and upstream from the first bypass valve 304a. The bypass line 354 branches from the line carrying the influent 126. The reservoir 356 is positioned alone the bypass line 354. The second bypass valve 352b is positioned downstream from the reservoir 356 and upstream from the first bypass valve 304a.

The reservoir allows operation independent of flow of the influent 126 from the process pipe 104. As an example, to store influent 126, the bypass valves 352a, 352b are closed. A desired volume of influent 126 is directed to the reservoir 356 via the bypass line 354. To release influent 126 from the reservoir, the first bypass valve 352a remains closed and the second bypass valve 352b is opened.

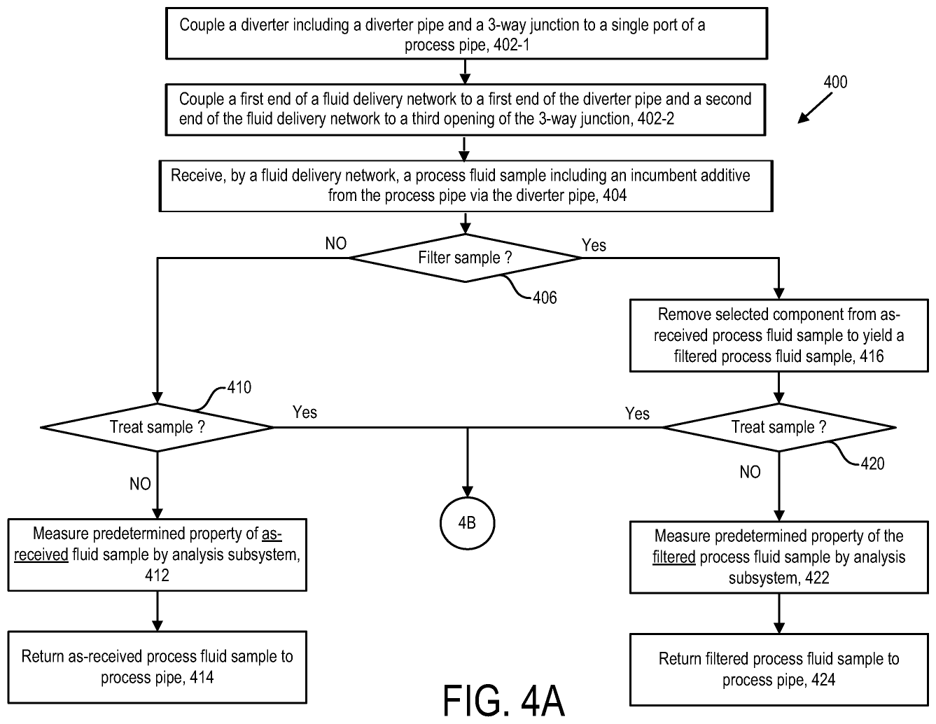

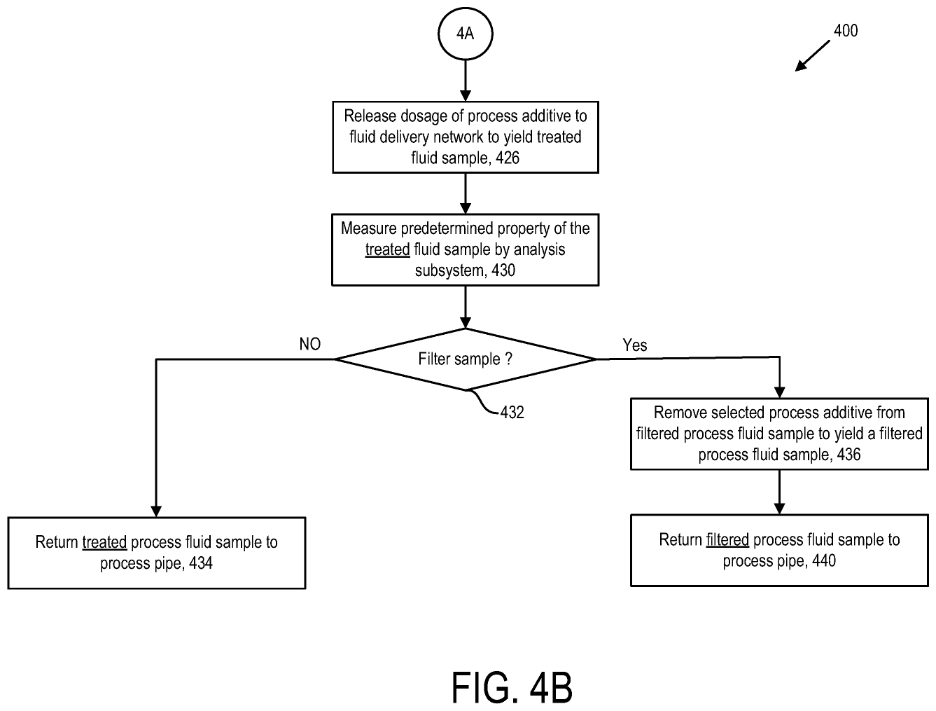

FIGS. 4A-4B are flow diagrams illustrating an exemplary embodiment of a method 400 for monitoring fluid properties of the process fluid 106 diverted from the process pipe 104. The method 400 is described below with reference to the monitoring assembly 102 of FIGS. 1-3B. As shown, the method 400 includes operations 402-1 to 440. However, in alternative embodiments, one or more operations can be added or removed and the operations can be performed in a different order than illustrated in FIGS. 4A-4B. As discussed in detail below, the first mode of operation of the monitoring assembly 102 is performed in operations 402-1 to 414, the second mode of operation of the monitoring assembly 102 is performed in operations 402-1 to 406 and 416-424, and the third mode of operation of the monitoring assembly 102 is performed in operations 402-1 to 406, 410 or 416 to 420, and 426-440.

In operation 402-1, the diverter 110 is coupled to a single port of the process pipe 104 (e.g., port 124). As an example, the diverter pipe 108 can be inserted within the port tube 204 and the coupling mechanism 210 (e.g., the first opening 210a of the three-way junction 210) can be coupled to the port tube 204. In certain embodiments, the second end 108b of the diverter pipe 108 can extend a predetermined distance beyond the outer wall 202 of the process pipe 104. In this manner, a process fluid sample returned to the process pipe 104 (e.g., effluent 130) can avoid mixing with a process fluid sample drawn from the process pipe 104 (e.g., influent 126), ensuring that the influent 126 is representative of the process fluid 106 within the process pipe 104.

In operation 402-2, the first end 122a of the fluid delivery network 122 is coupled to the first end 108a of the diverter pipe 108. The second end 122b of the fluid delivery network 122 is further coupled to the third opening 210c of the three-way junction 210.

In operation 404, the fluid delivery network 122 can receive a process fluid sample (e.g., influent 126) from the process pipe 104 via the diverter 110 (e.g., diverter pipe 108). As discussed above, the fluid delivery network 122 can be in fluid communication with the diverter pipe 108. The fluid delivery network 122 can be in further fluid communication with the analysis subsystem 116, the conditioning subsystem 118, and, optionally, the filtration subsystem 120 when present. Under some circumstances, the influent 126 can include one or more incumbent additives. In alternative embodiments, the influent can contain no incumbent additives or incumbent additives in trace amounts that do not affect its fluid properties.

In the first mode of operation, the properties of the influent 126 in the as-received state can be measured by the analysis subsystem 116. Such measurements can be advantageous for obtaining baseline measurements of one or more predetermined properties of the process fluid 106 in an as-received state for comparison to measurements of the process fluid in other states (e.g., filtered, treated, etc.). The influent 126 can avoid filtration by the filtration subsystem 120 (decision block 410: NO) by diverting the influent 126 through the bypass portion 300 of the fluid delivery network 122. The influent 126 can avoid treatment by the conditioning subsystem 118 (decision block 412: NO) by maintaining the reservoir valve 314 in the closed position.

Under these circumstances, the method 400 moves through decision block 406 and decision block 410 to operations 412-414. In operation 412, one or more predetermined properties of the influent 126 are measured by the analysis subsystem 116. As discussed above, examples of the predetermined properties can include corrosion rate of the process pipe 104, concentration of gases (e.g., oxygen, carbon dioxide, carbon monoxide, nitrogen, H₂S), pH, water cut, physical properties of the influent 126 (e.g., temperature, pressure, flow rate, viscosity, drag, turbulence, salinity, density, conductivity). The analysis subsystem 116 can output one or more sensor signals 322s representative of the measured predetermined property of the influent 126 for receipt by the controller 114. Subsequently, in operation 412, the influent 126 can be directed from the analysis subsystem 116 to the diverter 110 (e.g., the third opening 210c of the three-way junction 210), via the fluid delivery network 122, after sensing the predetermined property. The measured influent 126 can be returned to the process pipe 104 as effluent 130 via the channel formed by the outer wall of the diverter pipe 108, the inner wall of the coupling mechanism 210, and the inner wall of the port tube 204. The pump 330 can be employed to facilitate return of the effluent 130 to the process pipe 104.

In the second mode of operation, the properties of the influent 126 in the filtered state can be measured. Such measurements can be advantageous for obtaining baseline measurements of one or more predetermined properties of the process fluid 106 in the filtered state (filtered influent 1260 for comparison to measurements of the process fluid in other states (e.g., as-received, treated, etc.). The influent 126 can be subjected to filtration by directing the influent 126 through at least a portion of the filtration subsystem 120 (decision block 410: YES). The influent 126 can avoid treatment by the conditioning subsystem 118 (decision block 412: NO) by maintaining the reservoir valve 314 in the closed position.

Under these circumstances, the method 400 moves through decision block 406 to operation 416, decision block 420, and operations 422-424. In operation 416, the influent 126 is directed from the diverter pipe 108 to the filtration subsystem 120, upstream from the analysis subsystem 116. The filtration subsystem 120 can be configured to remove one or more selected components from the influent 126 to provide the filtered influent 126f. As discussed above, examples of the selected components can include particulates and at least a portion of an one or more incumbent additives. The first filter 120a of the filtration subsystem 120 can be configured to remove particulates, and the second filter 120b of the filtration subsystem 120 can be configured to remove incumbent additives.

Optionally, at least one of the first filter 120a or the second filter 120b can be bypassed by directing the influent 126 through the bypass portion 300 using the bypass valves (e.g., 304a, 304b, 304c, 304d, 304e). Bypass of the first filter 120a can be advantageous under circumstances where particulates present in the influent 126 are not considered detrimental to the operation (e.g. efficiency, health) of the monitoring system 112. Bypass of the second filter 120b can be advantageous under circumstances where only removal of particulates from the influent 126 is desired prior to analysis by the analysis subsystem 116.

Subsequently, the method 400 can move from operation 416, through decision block 420 (NO) to operations 422-424. In operations 422-424, the filtered influent 126f can be directed to the analysis subsystem 116 for measurement and then returned to the process pipe 104, similar to operations 412-414.

In the third mode of operation, the properties of the influent 126 can be measured in the treated state. Measurements of the properties of the influent 126 in the treated state (treated influent 126t) can be desirable on their own and/or for comparison to the baseline measurements of the influent 126 in the as-received state (influent 126) and/or filtered state (filtered influent 1260. In certain embodiments, the influent 126 can be in the as-received state prior to treatment (e.g., decision block 410: YES). In other embodiments, the influent 126 can be in the filtered state prior to treatment (e.g., decision block 420: YES).

Under these circumstances, the method 400 moves from decision block 406 through either decision block 410 or decision block 420, depending upon whether filtration of the influent 136 is performed to operation 426, as illustrated in FIG. 4A.

With further reference to FIG. 4B, in operation 426, when the method 400 enters operation 126 from decision block 410, the as-received influent 126 can be directed from the diverter pipe 108 to the conditioning subsystem 118 for treatment, producing treated influent 126t. Alternatively, when the method 400 enters operation 426 from decision block 420, the filtered influent 126f can be directed from the filtration subsystem 120 to the conditioning subsystem 118, upstream from the analysis subsystem 116, to produce the treated influent 126t. In either case, the method 400 can subsequently move from operation 426 to operation 430, where one or more properties of the treated influent 126t can be measured by the analysis subsystem 116, as discussed above with respect to operation 414.

In decision block 432, a decision is made whether or not to filter the treated influent 126t. Under circumstances where the treated influent 126t is not filtered (decision block 432: NO), the treated influent 126t can be returned to the diverter 110 via the fluid delivery network 122 as effluent 130 for return to the process pipe 104 via the channel. Under circumstances where the treated influent 126t is filtered (decision block 432: YES), the method 400 can move to operation 436, where the treated influent 126t is directed to the third filter 120c for removal of one or more process additives 312. The third filter 120c can be configured similar to the second filter 120b and can include chemical filter media configured to separate selected incumbent additive(s) from the treated influent 126t by adsorption or absorption. Following filtration by the third filter 120c, the method 400 can move from operation 436 to operation 440, the filtered process fluid (e.g., effluent 130) can be returned to the process pipe 104 via the fluid delivery network 122 and the diverter 110 (e.g., the channel).

Exemplary technical effects of the methods, systems, and devices described herein include, by way of non-limiting example rapid screening of multiple additive chemistries in rapid succession and acquisition of real-time performance data and chemical effects on process fluids. Embodiments of the disclosed monitoring assembly can be coupled to a process pipe at an existing port (e.g., a coupon port), avoiding the need for modification of the pipe.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A monitoring assembly, comprising:
a diverter including a diverter pipe extending between a first end and a second end, a three-way junction including first and second openings positioned opposite one another along an axis A, and a third opening positioned transverse to the axis A, wherein the three-way junction is configured to fluidly couple to a single port of a process pipe including a port tube and a port valve positioned therein;
a fluid delivery network extending between a first end and a second end, the first end of the fluid delivery network being configured to fluidly couple to the first end of the diverter pipe and the second end of the fluid delivery network being configured to fluidly couple to the third opening of the three-way junction;
wherein, when the three-way junction is fluidly coupled to the single port of the process pipe, the diverter pipe is configured to move between a retracted position in which the second end of the diverter pipe does not extend through the port valve and an extended position in which the second end of the diverter pipe extends through the port valve and transports a process fluid including an incumbent additive from the process pipe to the first end of the fluid delivery network;
an analysis subsystem configured to receive the process fluid from the fluid delivery network, to measure a predetermined property of the received process fluid within a sensing chamber, and to output a signal representing the measured predetermined property; and
a pump configured to urge the process fluid from the analysis subsystem to the diverter via the second end of the fluid delivery network;
wherein an outer wall of the diverter pipe and an inner wall of the port tube form a channel extending from the three-way junction to the process pipe configured to receive the process fluid from the second end of the fluid delivery network.

2. The system of claim 1, wherein the diverter pipe and the port tube are approximately concentric with respect to one another about the axis A when the three-way junction is coupled to the port tube.

3. The system of claim 1, wherein the second end of the diverter pipe is configured to extend a predetermined distance beyond a wall of the process pipe in the extended position.

4. The system of claim 1, further comprising a controller in signal communication with one or more valves of the fluid delivery network, wherein the controller is configured to provide commands to the valves for directing the process fluid received within the fluid delivery network.

5. The system of claim 4, further comprising a filtration subsystem in fluid communication with the fluid delivery network downstream from the diverter pipe, the filtration subsystem including a first filter configured to remove at least a portion of the incumbent additive from the process fluid to produce a filtered process fluid, and to output the filtered process fluid to the fluid delivery network.

6. The system of claim 5, wherein incumbent additive is a corrosion inhibitor and the first filter comprises a chemical filter configured to remove at least a portion of the corrosion inhibitor from the process fluid.

7. The system of claim 5, wherein the filtration subsystem further comprises a second filter configured to remove selected particulates from the process fluid.

8. The system of claim 5, wherein the fluid delivery network further comprises a bypass portion configured to divert the process fluid from at least a portion of the filtration subsystem.

9. The system of claim 5, wherein the bypass portion comprises:
a bypass channel including a first end positioned upstream from the first filter and a second end positioned downstream from the incumbent filter; and
one or more bypass valves in signal communication with the controller;
wherein the controller is configured to command the one or more bypass valves to move between a first configuration that permits flow of the process fluid to the first filter and a second configuration that diverts flow of the process fluid away from the first filter and into the bypass channel.

10. The system of claim 5, further comprising a conditioning subsystem including:
a reservoir containing a process additive; and
a reservoir valve in fluid communication with the reservoir and the fluid delivery network upstream from the analysis subsystem.

11. The system of claim 10, wherein the controller is configured to command the reservoir valve to:
permit flow of a predetermined amount of the process additive to the fluid delivery network to provide a treated process fluid including the process fluid and the process additive to the analysis subsystem; and
inhibit flow of the process additive to the fluid delivery network to provide the process fluid without the process additive to the analysis subsystem.

12. The system of claim 1, wherein the predetermined property is a corrosion rate of a material forming the process pipe.

13. A method, comprising:
coupling a diverter to a single port of a process pipe including a port tube and a port valve, the diverter including a diverter pipe extending between a first end and a second end and a three-way junction including first and second openings positioned opposite one another along an axis A and a third opening positioned transverse to the axis A, wherein the first opening of the three-way junction is fluidly coupled to the port tube;
coupling a first end of a fluid delivery network to the first end of the diverter pipe and a second end of the fluid delivery network to the third opening of the three-way junction;
receiving, by the fluid delivery network, a process fluid sample from the process pipe, the process fluid sample including an incumbent additive;
receiving, by an analysis subsystem, the process fluid sample;
measuring, by the analysis subsystem, a predetermined property of the process fluid sample;
outputting, by the analysis subsystem, a sensor signal representative of the measured predetermined property of the process fluid sample;
directing the process fluid sample from the analysis subsystem to the third opening of the three-way junction via the fluid delivery network after sensing the predetermined property; and
directing the process fluid sample from the three-way junction to the process pipe via a channel formed by an outer wall of the diverter pipe and an inner wall of the port tube.

14. The method of claim 13, wherein the diverter pipe and the port tube are approximately concentric with respect to one another about the axis A when the three-way junction is coupled to the port tube.

15. The method of claim 13, wherein the diverter pipe is configured to move between a retracted position in which the second end of the diverter pipe does not extend through the port valve and an extended position in which the second end of the diverter pipe extends through the port valve.

16. The method of claim 15, wherein the second end of the diverter pipe is configured to extend a predetermined distance beyond a wall of the process pipe in the extended position.

17. The method of claim 13, wherein the predetermined property is a corrosion rate of a material forming the process pipe.

18. The method of claim 13, further comprising:
directing the process fluid sample from the diverter pipe to a filtration subsystem positioned upstream from the analysis subsystem;
removing at least a portion of the incumbent additive from the process fluid sample by the filtration subsystem to provide a filtered process fluid; and
directing the filtered process fluid to the analysis subsystem.

19. The method of claim 18, wherein incumbent additive is a corrosion inhibitor.

20. The method of claim 18, wherein the filtration subsystem is further configured to remove selected particulates from the process fluid.

21. The method of claim 18, further comprising:
directing the process fluid sample from the filtration subsystem to a conditioning subsystem upstream from the analysis subsystem and downstream from the filtration subsystem;
releasing a dosage of a process additive from the conditioning subsystem to the fluid delivery network downstream from the filtration subsystem to produce a treated process fluid sample including the filtered process fluid and the process additive; and
directing the treated process fluid sample to the analysis subsystem for measurement of the predetermined property.

22. The method of claim 13, further comprising:
directing the process fluid sample from the diverter pipe to a conditioning subsystem positioned upstream from the analysis subsystem;
releasing a dosage of a process additive from the conditioning subsystem to the fluid delivery network upstream from the analysis subsystem to produce a treated process fluid sample including the process fluid as-received by the diverter pipe and the process additive;
directing the treated process fluid sample to the analysis subsystem for measurement of the predetermined property.
